(19) United States
(12) Patent Application Publication
(10) Pub. No.: US 2025/0096474 A1
(43) Pub. Date: Mar. 20, 2025

(54) DUAL RFID ANTENNA

(71) Applicant: Avery Dennison Retail Information Services LLC, Mentor, OH (US)

(72) Inventor: Ian J. FORSTER, Chelmsford (GB)

(21) Appl. No.: 18/727,802

(22) PCT Filed: Feb. 16, 2023
(86) PCT No.: PCT/IB2023/051382

§ 371 Date: Jul. 10, 2024

Related U.S. Application Data
(60) Provisional application No. 63/311,118, filed on Feb. 17, 2022.

(51) Int. Cl. H01Q 9/40; H01Q 1/22; H01Q 5/40; H01Q 7/00

(52) U.S. Cl. CPC H01Q 9/40; H01Q 1/2225; H01Q 5/40; H01Q 7/00

(57) ABSTRACT

An antenna configured to support high frequency and ultra-high frequency RFID modes includes a coiled metal trace configured to provide low resistance and high Q for operation as a loop antenna in a high frequency mode. Adjacent sections of the coiled metal trace are separated by a narrow gap of about 200 μm or less for ultra-high frequency coupling between adjacent sections of the metal trace for operation as a monopole or dipole antenna in an ultra-high frequency mode. The antenna may include a ground plane configured to be disposed in proximity to the metal trace to substantially reduce the effect of environmental metal proximate to the antenna during operation of the antenna in the high frequency mode or ultra-high frequency mode. The antenna may include a dielectric configured to be disposed between the ground plane and the metal trace.

### CROSS-REFERENCE TO RELATED APPLICATION

This application claims the benefit of U.S. Provisional Patent Application No. 63/311,118, filed Feb. 17, 2022, the disclosure of which is hereby incorporated herein by reference in its entirety.

### TECHNICAL FIELD

The present application generally relates to combined HF and UHF antennas, and specifically to antenna structures configured to support multiple RFID operations.

### BACKGROUND

Certain radio frequency identification (RFID) systems operate in the high frequency (HF) range, nominally at 13.56 MHz, while other RFID systems operate in the ultra-high frequency (UHF) range, for example between 800 MHz to 900 MHz, or the super high frequency (SHF) range, for example between 2400 to 2500 MHz. HF RFID systems typically include a tuning loop coupled to an RFID chip that powers the RFID chip when excited by a nearby field at the resonant frequency of the HF antenna and internal capacitance of the RFID chip. The RFID chip sends a coded return signal when powered. RFID systems operating in the UHF or SHF range include dipole or monopole antennas rather than coil loop antennas. Typically, HF, UHF, and SHF based RFID devices are used for different purposes and are manufactured and sold as separate items with separate antennas.

### SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the disclosed subject matter in a simplified form as a prelude to the more detailed description that is presented later.

The present disclosure describes a system and method employing, in some instances, an antenna that may be configured and operative to support high frequency and ultra-high frequency radio bands (such as, e.g., those used in certain RFID modes), which antenna may include a coiled metal trace to provide low resistance and high “quality factor” (Q) for operation as a loop antenna in a high frequency band. Adjacent sections of the coiled metal trace may be separated by a suitably narrow gap (of about 200 μm or less, in some circumstances) for ultra-high frequency coupling between adjacent sections of the metal trace for operation as a monopole or dipole antenna in one or more of an ultra-high frequency band and a super high frequency band.

In accordance with one aspect of the disclosed subject matter, a device may generally comprise: a first Radio Frequency Identification (RFID) chip configured to operate at a high frequency (HF) in conjunction with an HF tuning loop; an HF coil antenna conductively coupled to the first RFID chip and configured as the HF tuning loop; and a second RFID chip configured to operate at either an ultra-high frequency (UHF) or a super high frequency (SHF) in conjunction with a monopole antenna; wherein the HF coil antenna comprises a metal trace having sections separated by a narrow gap; wherein the metal trace and the narrow gap of the HF coil antenna substantially allow the HF coil antenna to function as the monopole antenna; and wherein the second RFID chip is suitably coupled to the metal trace of the HF coil antenna so as to match impedance with the monopole antenna.

Devices are disclosed wherein the narrow gap between the sections of the metal trace is about 200 μm or less. Some devices may generally further include a metal ground plane to be disposed in proximity of the HF coil antenna, wherein the metal ground plane is further configured to substantively reduce the effect of metal proximate to the device on the resonant frequency of the first RFID chip and the HF tuning loop and the second RFID chip and the monopole antenna.

Some devices are disclosed, further comprising a dielectric substrate disposed between the metal ground plane and the HF coil antenna. In some such instances, the dielectric substrate may include a fold line, wherein the metal ground plane is disposed under the HF coil antenna when the device is folded at the fold line.

In accordance with another aspect of the present disclosure, an antenna structure may generally comprise: a substantially flat coiled metal trace configured to provide low resistance and high quality factor (Q) for operation in a first HF mode; and a gap disposed between adjacent sections of the coiled metal trace configured to allow UHF and/or SHF coupling between the adjacent sections for operation in a second UHF or SHF mode; wherein respective ends of the metal trace are configured to suitably couple to a first RFID chip for operation in the first HF mode; and wherein a section of the metal trace is configured to suitably couple to a second RFID chip for operation in the second UHF or SHF mode.

Implementations of such an antenna structure are disclosed wherein the gap disposed between adjacent sections of the metal trace is about 200 μm or less. Additionally or alternatively, the metal trace may be configured to operate as one of a monopole antenna or a dipole in the second UHF or SHF mode. Further, a metal ground plane may be configured to be disposed in proximity of the metal trace, wherein the metal ground plane is further configured to substantively reduce the effect on the resonant frequencies of the first RFID chip and the second RFID chip of metal in the environment that is proximate to the antenna structure.

In some implementations, a dielectric substrate may be configured to be disposed between the metal ground plane and the metal trace. In accordance with some aspects, the dielectric substrate includes a fold line, and the metal ground plane is configured to be disposed under the metal trace when the antenna structure is folded at the fold line.

In accordance with yet another aspect of the disclosed subject matter, a method of employing a single antenna to support multiple radio devices may generally comprise: providing a substantially flat coiled metal trace operative to provide low resistance and high Q for operation in a first radio band; the providing comprising maintaining a gap disposed between adjacent sections of the coiled metal trace, wherein the gap is dimensioned to allow coupling between the adjacent sections which enables operation in a second radio band; selectively electrically coupling opposing ends of the metal trace to a first radio frequency chip for operation in the first radio band; and selectively electrically coupling a section of the metal trace to a second radio frequency chip for operation in the second radio band.

Methods are disclosed wherein the selectively electrically coupling a section of the metal trace operation enables the metal trace to operate as one of a monopole antenna or a dipole in the second radio band. Additional or alternatively, method are disclosed further comprising providing a ground plane operative to reduce an effect on a resonant frequency of one of the first radio frequency chip or the second radio frequency chip caused by presence of a metal in an environment that is proximate to the metal trace.

The foregoing and other aspects of various disclosed embodiments will be apparent through examination of the following detailed description thereof in conjunction with the accompanying drawing figures, in which similar reference numerals are used to represent similar components throughout unless otherwise noted.

### BRIEF DESCRIPTION OF THE DRAWINGS

FIG. 1A is a diagram of an example UHF RFID device.

FIG. 1B is a diagram of an example HF RFID device.

FIG. 2A is a diagram of an example UHF RFID tag configured to be disposed near metal.

FIG. 2B is a diagram of an example HF RFID tag configured to be disposed near metal.

FIG. 3 is a diagram of a combined HF/UHF RFID tag according to an embodiment of the disclosure.

FIG. 4 is a close up diagram of a portion of a combined HF/UHF antenna element structure according to an embodiment of the disclosure.

FIG. 5 is a diagram of a foldable RFID tag configured to be disposed near metal according to an embodiment of the disclosure.

FIG. 6 is a functional flow diagram illustrating aspects of one implementation of a method of employing a single antenna to support multiple radio devices operating on different frequency bands.

### DETAILED DESCRIPTION

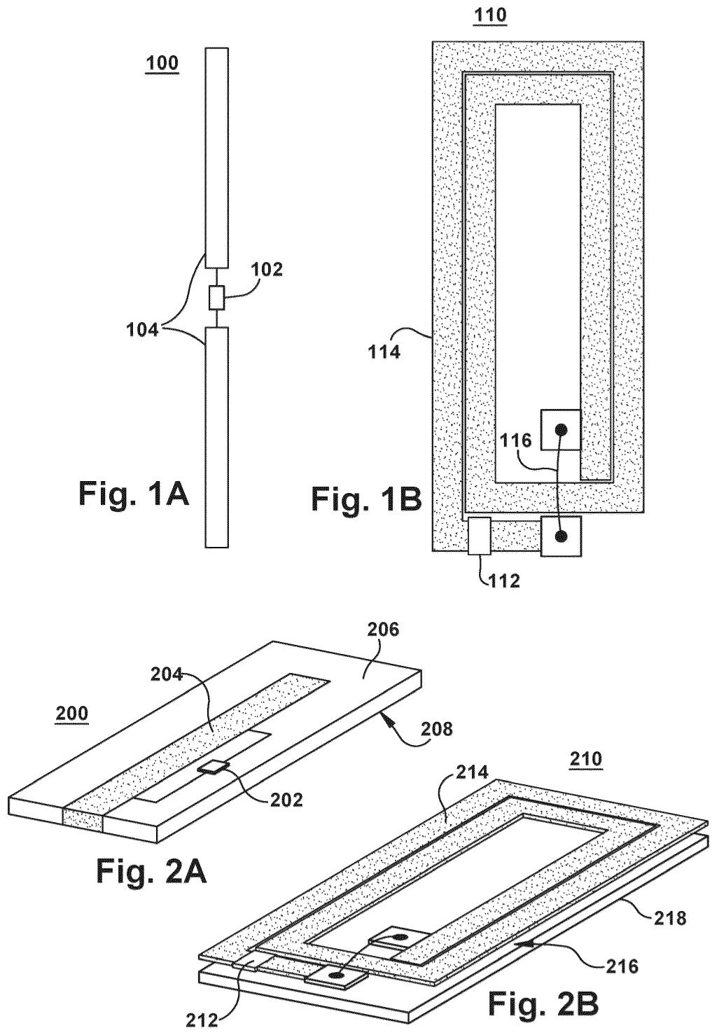

The systems and methods disclosed herein are described in detail by way of examples and with reference to the FIGS. 1A through 6. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The present disclosure illustrates new modalities for combining HF, UHF, and SHF antenna structures to support multiple RFID devices with a single antenna. The systems and methods disclosed herein describe various aspects of antenna structures and example placements of associated chips and straps for combining RFID circuits.

RFID devices that operate on different frequency bands are generally designed for different functions and are typically manufactured separately. RFID devices can be used for many different purposes including, for example, item identification, item tracking, and inventory. As can be appreciated, items can include different RFID devices to provide the respective benefits of each of the RFID devices.

Combining the functionality of different RFID devices into a single device can provide several advantages. One advantage is that combining multiple RFID devices into a single device reduces manufacturing and inventory costs required for multiple tags. A similar advantage is that a common set of antenna structures can be used for different devices. For example, the same antenna structures can be used for a simple low speed standalone RFID inventory device in one configuration, in another configuration the antenna structures can be used for higher speed RFID applications, and in yet another configuration the same antenna structures can be used for a combined RFID device. This advantageously reduces the number of different antenna structures that need to be manufactured to support different types of operations and devices.

Another advantage is that combining different RFID systems into a single device reduces the number of devices that must be separately attached to each item of commerce. Different supply chains can require the application of different tags to the same items. Using a combined device reduces the potential for damage to items that might be caused by numerous attachment points to an item. This also reduces the number of attached devices that might need to be removed by the consumer or merchant, potentially saving time and reducing labor costs.

Another advantage of combining different RFID systems into a single device is that the radio frequency elements can be purposefully isolated from one another to avoid interference. When different RFID devices are in close proximity, it is possible for the radio frequency elements in one device to interfere with the function of the other device. A single combined device can be designed to reduce the likelihood of interference.

Another advantage of combining different RFID systems into a single device is that the devices can be designed to specifically overcome a common problem. For example, when RFID devices are in proximity to metal structures, the operations of those devices can be blocked, obstructed, impaired, or altered by the presence of the metal, depending upon where the metal is in relation to the device, the type of metal, and the amount of metal. By designing a combined antenna structure to accommodate the presence of metal, the problem can be addressed in both devices simultaneously, reducing the likelihood that solving the problem in one device might incidentally affect the operation of another adjacent RFID device.

Although the examples presented below specifically address RFID systems, the disclosed systems and methods are also applicable to other types of radio frequency systems. For example, electronic article surveillance (EAS) systems typically operate in the high frequency (HF) range, nominally at 8.2 MHz. EAS devices are generally attached to items and are used to prevent theft of those items from stores by requiring deactivation of the EAS device at a point-of-sale terminal when purchased. Consumer goods can include both an EAS device to address theft protection and an RFID device for inventory management. The systems and methods described herein can be used to combine EAS and RFID devices as well as other types of radio frequency systems, such as low frequency (LF), 5.8 GHz super high frequency (SHF) systems, NFC, and Bluetooth® radio frequency systems.

Turning to FIG. 1A, a first RFID tag 100 is illustrated. The RFID tag 100 includes an RFID chip 102 electrically coupled to a dipole antenna 104. The RFID tag 100 operates in the ultra-high frequency (UHF) or super high frequency (SHF) spectrum, for example 800-900 MHz for UHF and 2400-2500 MHz for SHF. Dipole antennas 104 operating in the UHF/SHF spectrum are designed primarily to work in the far field electromagnetic propagation mode although as one skilled in the art will appreciate, dipole antennas 104 also have near field characteristics.

Turning to FIG. 1B, a second RFID tag 110 is illustrated. The RFID tag 110 comprises an RFID chip 112 electrically coupled to a coil antenna 114. A bridge 116 is configured to electrically couple the inner and outer coil ends of the coil antenna 114. The RFID tag 110 operates in the high frequency (HF) spectrum, for example for example at or near 13.56 MHz. Coil antennas 114 operating in the HF spectrum are designed primarily to be driven by a near magnetic field reader such as that incorporated into cellphones or handheld readers.

Turning to FIGS. 2A and 2B, examples of surface insensitive antenna structures are presented. FIG. 2A presents a UHF monopole 200 comprising an RFID chip 202 in electrical communication with a strip of metal that functions as the monopole antenna element 204. The monopole antenna element 204 is wrapped around a dielectric 206 such as plastic, PET or polyethylene, or a low dielectric constant foam, with a metallic back 208 that acts as the ground plane. The ground plane allows the UHF monopole 200 to be placed on or in proximity to a metal surface. The efficiency of the UHF monopole 200 can depend on the thickness of the dielectric 208, for example for a spacing of 1 mm an air dialectic, or the equivalent, can achieve −6 dBi.

FIG. 2B presents an HF tag 210 including an RFID chip 212 in communication with a coil antenna 214. The coil antenna 214 is separated from a metal plane 218 by an air gap 216 or dielectric such as the dielectric of FIG. 2A. The performance of the HF tag 210 can be limited by eddy current induction into the ground plane 218 and the effect of the metal surface on the tuning of the HF tag 210 which is pushed up in frequency by the presence of the metal surface. The HF tag 210 can be compensated by making the free space resonant frequency below 13.56 MHz so that the HF tag 210 resonates at 13.56 MHz in the presence of the metal.

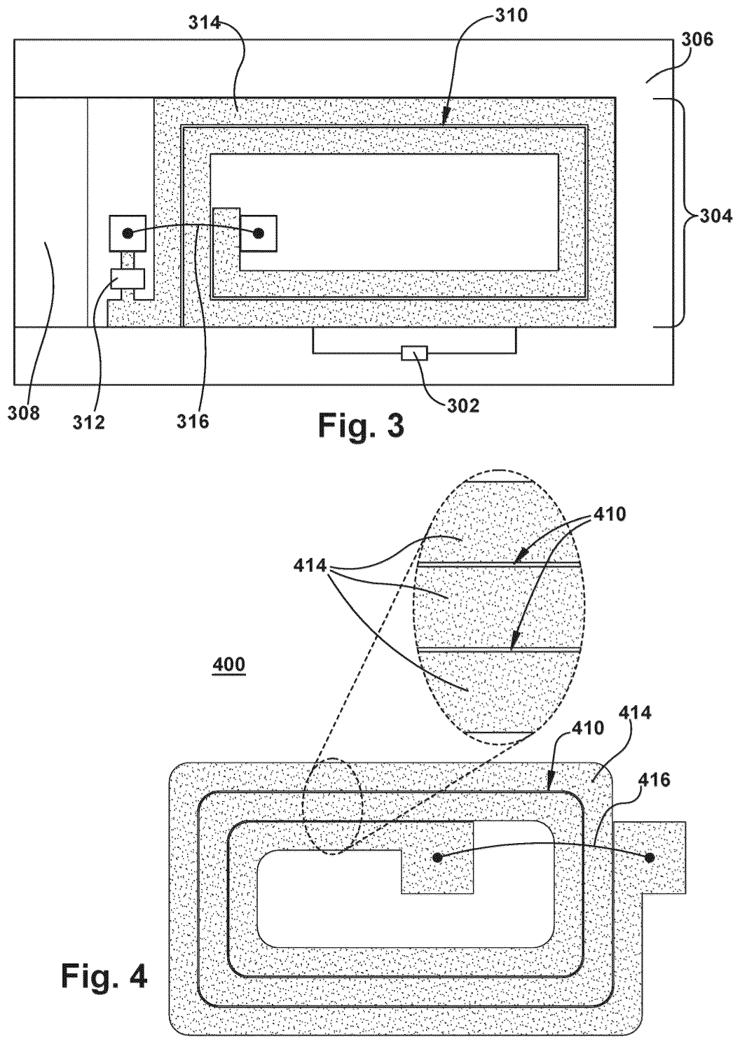

Turning to FIG. 3, an example of a combined antenna structure 300 is presented. The combined antenna structure 300 includes a first RFID chip 302 configured to use the combined antenna structure 300 as a UHF monopole antenna element 304. The combined antenna structure 300 can also be used as a SHF monopole antenna as would be understood in the art. The combined antenna structure 300 also includes a second RFID chip 312 configured to use the HF coil antenna structure 314 as an HF antenna. The coil antenna structure 314 includes a bridge 316 that electrically connects the ends of the coil antenna structure 314 into a loop for efficient radiation of HF frequencies. The RFID chips 302, 312 can be directly attached to the coil antenna structure 314, commonly described as a flip chip, or can be attached to the coil antenna structure 314 with a strap as described in U.S. Pat. Nos. 7,158,037 and 7,292,148, each of which is incorporated herein by reference in their respective entireties.

The metal tracks of the coil antenna structure 314 are separated by a narrow gap 310, for example a gap of about 200 μm or less, such that the coupling at UHF frequencies is high enough that the coil antenna structure 314 behaves similarly to a solid conductor, allowing the first RFID chip 302 to use the combined antenna structure 300 as a UHF monopole antenna element 304. The first RFID chip 302 is coupled to the metal tracks of the coil antenna structure 314 at suitable points to get an impedance match.

The combined antenna structure 300 also includes a dielectric substrate 306 such as plastic, PET or polyethylene, or a low dielectric constant foam, onto which the coil antenna structure 314 and RFID chips 302, 312 are mounted. A metal ground plane 308 can be wrapped around or positioned beneath the dielectric substrate 306 to act as the ground plane. In various embodiments, the metal ground plane 308 can be configured to be disposed only on the back of the dielectric substrate 306, wrapped partially around the dielectric substrate 306 as illustrated, or wrapped completely around the dielectric substrate 306 as would be understood in the art. The ground plane allows the combined antenna structure 300 to be placed on or in proximity to a metal surface without substantively affecting the performance of the RFID chips 302, 312 and associated systems.

Turning to FIG. 4, an expanded view of a coil antenna 400 is presented. The coil antenna 400 includes a wide metal track 414 configured in a loop or coil separated by narrow gaps 410. A bridge 416 couples the ends of the metal track 414. The metal tracks 414 of coil antenna 400 are configured to be wide so as to decrease resistance and increase Q, resulting in better performance at HF frequencies; in this context, it will be appreciated that “Q” represents “quality factor,” specifically, a ratio of energy stored in a radio oscillator versus an amount of energy that is lost, on a per cycle basis, by operation of the oscillator. The gaps 410 are configured to be narrow so as to provide tight coupling between the metal tracks 414 at UHF and SHF frequencies to make the coil antenna 400 an efficient radiator at UHF and SHF frequencies. In some implementations, the gaps 410 can be cut or etched using a suitable process such as laser cutting.

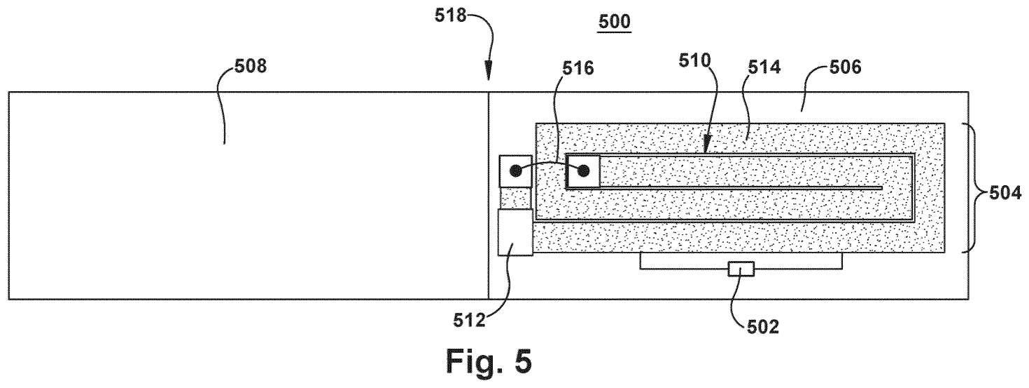

Turning to FIG. 5, a diagram of a foldable RFID tag 500 is presented. The foldable RFID tag 500 includes a coiled metal track 514 disposed on a substrate 506. The coils of the metal track 514 are separated by a narrow gap 510 such as is described above with regard to FIG. 4. A bridge 516 couples the ends of the metal track 514 so as to form a loop. The foldable RFID tag 500 includes an HF RFID chip 512. At HF frequencies, the metal track 514 and bridge 516 form a suitable tuning loop for the HF RFID chip 512. The foldable RFID tag 500 also includes a UHF/SHF RFID chip 502 suitably disposed along part of the metal track 514 to obtain a proper impedance match. At UHF/SHF frequencies, the metal track 514 and narrow gap 510 function as a monopole antenna 504 for the UHF/SHF RFID chip 502.

The foldable RFID tag 500 can include a fold line 518 to facilitate folding the foldable RFID tag 500 around a dielectric such as plastic, PET or polyethylene, or a low dielectric constant foam. In embodiments, the substrate 506 can be the dielectric or a separate dielectric can be included. When folded about the fold line 518, a metallic ground plane 508 is positioned proximate to and beneath the metal track 514. The metallic ground plane 508 allows the foldable RFID tag 500 to be placed on or in proximity to a metal surface and substantively reduces the effect of any nearby metal surface on the performance of the RFID chips 502, 512. As can be appreciated however, in other embodiments, similar benefits can be achieved by integrating the metal ground plane as a separate layer of a non-folding RFID tag.

RFID tags are often used in environments where metal or liquids are present. The presence of metal or liquids in proximity to the RFID tags can change the resonant frequencies of the RFID tags and therefore affect the performance of the RFID tags. Including a ground plane in the RFID tags helps to reduce the effect of the environment on the function of the RFID tags and also allows RFID tags to be directly placed on metal surfaces or in proximity to liquids without substantively affecting the performance of the RFID tags.

In retail and other environments, multiple RFID devices may be attached to a single item of commerce. If each RFID device included its own ground plane, there would be the potential for the ground planes of adjacent RFID devices to affect one another. By including multiple RFID devices on a single device with a single antenna structure, not only are the number of individual RFID tags attached to the item of commerce reduced, but the ground plane can be designed to work for all of the RFID devices on the tag eliminating the possibility of interference from other nearby RFID tags.

It will be appreciated that the structures and methods describe herein are also suitable for dipole or other antenna structures such as patches as would be understood in the art.

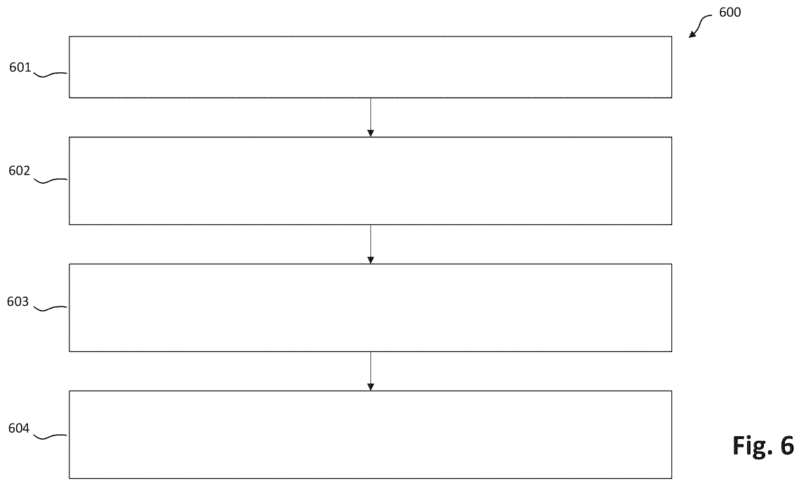

FIG. 6 is a functional flow diagram illustrating aspects of one implementation of a method of employing a single antenna to support multiple radio devices operating on different frequency bands. As illustrated in FIG. 6, a method 600 of employing a single antenna to support multiple radio devices may generally begin with providing a substantially flat coiled metal trace at block 601. As indicated above in connection with FIGS. 3 and 4, providing a substantially flat coiled metal trace that is operative to provide low resistance and high Q for operation in a first radio band may generally comprise maintaining a gap disposed between adjacent sections of the coiled metal trace (see reference numerals 310 and 410 in FIGS. 3 and 4, respectively) as indicated at block 602. In some circumstances, such a gap may be dimensioned to allow coupling between the adjacent sections substantially as set forth above. In some implementations noted above, for example, a gap of about 200 μm or less may enable coupling at UHF frequencies such that a coiled antenna structure (e.g., coiled metal trace 314) behaves similarly to a solid conductor, allowing a second RFID chip (see reference numeral 302 in FIG. 3) to use a combined antenna structure 300 as a UHF monopole antenna element 304, while a first RFID chip (see reference numeral 312 in FIG. 3) may use it as a tuning loop.

Method 600 may continue by selectively electrically coupling opposing ends of a metal trace (such as coiled metal trace 314) to a first radio frequency chip for operation in a first radio band as illustrated and described above with reference to FIGS. 3 and 5. In this case, the first radio frequency chip (such as illustrated at reference numerals 312 and 512) may be an HF radio device that is configured and operative to use the metal trace antenna structure (such as reference numeral 314) as an HF antenna.

Method 600 may then continue by selectively electrically coupling a section of the metal trace (such as coiled metal trace 314) to a second radio frequency chip (such as illustrated at reference numerals 302 and 502) for operation in the second radio band. This second radio frequency chip may be a UHF or SHF radio device that is configured and operative to use the metal trace antenna structure (such as reference numeral 314) as an antenna in an appropriate frequency band.

It is noted that the arrangement of the blocks and the order of operations depicted in FIG. 6 are not intended to exclude other alternatives or options. For example, the operations depicted at blocks 601 and 602 may be reversed in order, or they may be made to occur substantially simultaneously in some implementations. Further, one or more of these operations may occur substantially simultaneously with the operations depicted at blocks 603 and 604 in instances where it may be desirable to do so, e.g., for efficiency, where processing or fabrication resources are sufficient, and the like. It will also be appreciated that the operations depicted at blocks 603 and 604 may be reversed in order, or be made to occur substantially concomitantly. Those of skill in the art will appreciate that the foregoing subject matter is susceptible of various design choices that may influence the order or arrangement of the operations depicted in FIG. 6.

The values disclosed herein are not to be understood as being strictly limited to the exact numerical values recited. Instead, unless otherwise specified, each such dimension is intended to mean both the recited value and a functionally equivalent range surrounding that value. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

1. A device, comprising:
a first Radio Frequency Identification (RFID) chip configured to operate at a high frequency (HF) in conjunction with an HF tuning loop;
an HF coil antenna conductively coupled to the first RFID chip and configured as the HF tuning loop; and
a second RFID chip configured to operate at either an ultra-high frequency (UHF) or a super high frequency (SHF) in conjunction with a monopole antenna;
wherein the HF coil antenna comprises a metal trace having sections separated by a narrow gap;
wherein the metal trace and the narrow gap of the HF coil antenna substantially allow the HF coil antenna to function as the monopole antenna; and
wherein the second RFID chip is suitably coupled to the metal trace of the HF coil antenna so as to match impedance with the monopole antenna.

2. The device of claim 1, wherein the narrow gap between the sections of the metal trace is about 200 μm or less.

3. The device of claim 1, further comprising:
a metal ground plane configured to be disposed in proximity of the HF coil antenna;
wherein the metal ground plane is further configured to substantively reduce the effect of metal proximate to the device on the resonant frequency of the first RFID chip and the HF tuning loop and the second RFID chip and the monopole antenna.

4. The device of claim 3, further comprising:
a dielectric substrate disposed between the metal ground plane and the HF coil antenna.

5. The device of claim 4, wherein the dielectric substrate includes a fold line, and wherein the metal ground plane is disposed under the HF coil antenna when the device is folded at the fold line.

6. An antenna structure, comprising:
a substantially flat coiled metal trace configured to provide low resistance and high quality factor (Q) for operation in a first HF mode; and
a gap disposed between adjacent sections of the coiled metal trace configured to allow UHF and/or SHF coupling between the adjacent sections for operation in a second UHF or SHF mode,
wherein respective ends of the metal trace are configured to suitably couple to a first RFID chip for operation in the first HF mode; and
wherein a section of the metal trace is configured to suitably couple to a second RFID chip for operation in the second UHF or SHF mode.

7. The antenna structure of claim 6, wherein the gap disposed between adjacent sections of the metal trace is about 200 μm or less.

8. The antenna structure of claim 6, wherein the metal trace is configured to operate as one of a monopole antenna or a dipole in the second UHF or SHF mode.

9. The antenna structure of claim 6, further comprising:
a metal ground plane configured to be disposed in proximity of the metal trace,
wherein the metal ground plane is further configured to substantively reduce the effect on the resonant frequencies of the first RFID chip and the second RFID chip of metal in the environment that is proximate to the antenna structure.

10. The antenna structure of claim 9, further comprising:
a dielectric substrate configured to be disposed between the metal ground plane and the metal trace.

11. The antenna structure of claim 10, wherein the dielectric substrate includes a fold line, and wherein the metal ground plane is configured to be disposed under the metal trace when the antenna structure is folded at the fold line.

12. A method of employing a single antenna to support multiple radio devices, the method comprising:
providing a substantially flat coiled metal trace operative to provide low resistance and high Q for operation in a first radio band; the providing comprising maintaining a gap disposed between adjacent sections of the coiled metal trace, wherein the gap is dimensioned to allow coupling between the adjacent sections which enables operation in a second radio band;
selectively electrically coupling opposing ends of the metal trace to a first radio frequency chip for operation in the first radio band; and
selectively electrically coupling a section of the metal trace to a second radio frequency chip for operation in the second radio band.

13. The method of claim 12, wherein the selectively electrically coupling a section of the metal trace operation enables the metal trace to operate as one of a monopole antenna or a dipole in the second radio band.

14. The method of claim 12 further comprising providing a ground plane operative to reduce an effect on a resonant frequency of one of the first radio frequency chip or the second radio frequency chip caused by presence of a metal in an environment that is proximate to the metal trace.

15. An antenna and ground plane configured to support multiple radio frequency devices at different resonant frequencies in proximity of environmental metal as substantially described herein.
